(19) United States
(12) Patent Application Publication
(10) Pub. No.: US 2025/0283510 A1
(43) Pub. Date: Sep. 11, 2025

(54) BEARING UNIT WITH RETAINING CAGE

(71) Applicants: AKTIEBOLAGET SKF, GOTEBORG (SE); SKF Aerospace France S.A.S, Perrigny (FR)

(72) Inventors: Federico DAL ZILIO, None (IT); Alexander MOCNIK, Steyr (AT); Carl Patric Daniel NORIN JANSSON, Göteborg (SE); Valentin Roger Claude FLEURY, Romans-sur-Isère (FR)

(21) Appl. No.: 19/062,233

(22) Filed: Feb. 25, 2025

(30) Foreign Application Priority Data
Mar. 8, 2024 (IT) 102024000005260

(51) Int. Cl. F16C 33/38; B33Y 80/00

(52) U.S. Cl. CPC F16C 33/3887; F16C 33/3856; B33Y 80/00

(57) ABSTRACT

A bearing unit has a radially outer ring, a radially inner ring and a retaining cage configured to retain a plurality of rolling bodies between the inner ring and the outer ring. The retaining cage is centered on the radially outer ring and includes a one-piece annular body including a first ring connected to a second ring by a plurality of bridges. A plurality of pockets in the annular body are configured to house and retain one of the plurality of rolling bodies, and the pockets are framed by the first ring and the second ring and are located between adjacent pairs of the bridges. Each of the plurality of pockets has a side wall having a circumference, and a plurality of circumferentially spaced circumferentially extending recesses of substantially square section are located in the side wall of each of the recesses.

### CROSS-REFERENCE

This application claims priority to Italian patent application no. 102024000005260 filed on Mar. 8, 2024, the contents of which are fully incorporated herein by reference.

### TECHNOLOGICAL FIELD

The present disclosure relates to a bearing unit with a retaining cage. In particular, the bearing unit is an angular-contact bearing unit for applications requiring high precision, for example machine tools.

### BACKGROUND

Known bearing units with a retaining cage include a radially outer ring, a radially inner ring, a plurality of rolling bodies, in particular balls, interposed between the inner ring and the outer ring to enable the relative rotation thereof, and a retaining cage that holds the balls in respective circumferential positions.

One known type of retaining cage comprises a one-piece annular body that defines a reference axis, the body of the cage delimiting substantially cylindrical cavities or pockets distributed about the reference axis. The balls are housed in these cavities, which define the positioning and holding of the balls.

These retaining cages are usually used in high-velocity, high-vibration bearing units, in particular for applications in the industrial sector, for example in machine tool spindles, and are typically made by injection molding a polymer material, including to compensate for poor lubrication conditions. As the bearing unit requires a high degree of precision, the cages for these applications must also meet this accuracy requirement. Therefore, the cages are finished with machine tools and must therefore have a very simple geometry. One drawback of this type of retaining cage is the frictional losses that occur between the cage and the rolling bodies that are held in the respective cavities of the cage.

### SUMMARY

An aspect of the present disclosure is to provide a bearing unit with a retaining cage that does not have the drawbacks described above.

Another aspect of the disclosure is a bearing unit having a central rotation axis, a radially outer ring, a radially inner ring, and a retaining cage configured to retain a plurality of rolling bodies between the inner ring and the outer ring. The retaining cage is centered on the radially outer ring and includes a one-piece annular body including a first ring connected to a second ring by a plurality of bridges. A plurality of pockets in the annular body are each configured to house and retain one of the plurality of rolling bodies, and the pockets are framed by the first ring and the second ring and are located between adjacent pairs of the bridges. Each of the plurality of pockets has a side wall having a circumference and a plurality of circumferentially spaced circumferentially extending recesses of substantially square section.

### BRIEF DESCRIPTION OF THE DRAWINGS

The invention is described below with reference to the attached drawings, which show non-limiting example embodiments thereof, in which:

FIG. 1 is an axonometric view of a bearing unit according to first preferred embodiment of the present disclosure.

FIG. 2 is an axonometric view of the retaining cage of the bearing unit of FIG. 1.

FIG. 3 is a detail view of a first portion of the retaining cage of FIG. 2.

FIG. 4 is a detail view of a second portion of the retaining cage of FIG. 2.

### DETAILED DESCRIPTION

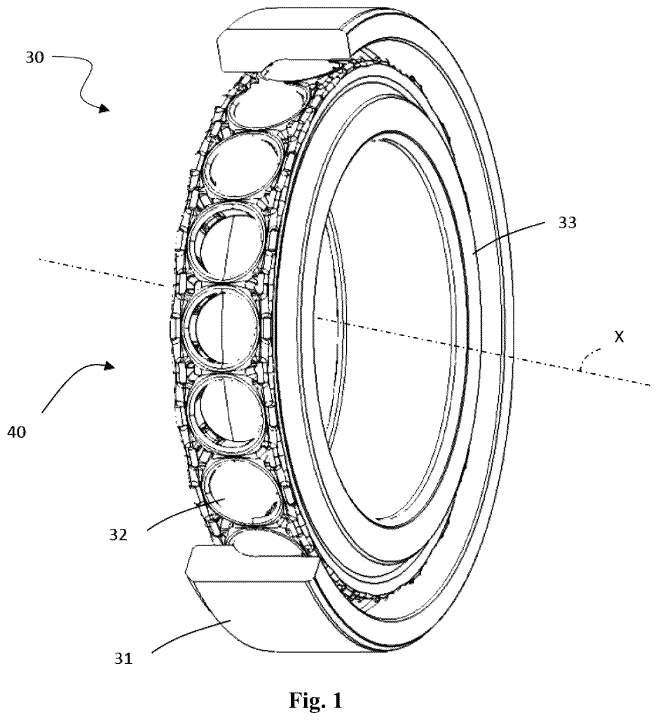

In FIG. 1, reference sign 30 denotes a bearing unit as a whole, according to a preferred embodiment of the present disclosure. The bearing unit 30 has a central rotation axis X and includes a stationary radially outer ring 31, a rotary radially inner ring 33, a row of rolling bodies 32, in particular balls, interposed between the radially outer ring 31 and the radially inner ring 33, and a cage 40 for holding the rolling bodies 32 in place, the cage being centered on the radially outer ring 31.

Throughout the present description and in the claims, terms and expressions indicating positions and orientations, such as “radial” and “axial”, are to be understood with reference to the central rotation axis X of the bearing unit 30, unless otherwise specified. For the sake of simplicity, the term “ball” may be used by way of example in the present description and in the attached drawings instead of the more generic term “rolling body”, and the same reference signs shall be used.

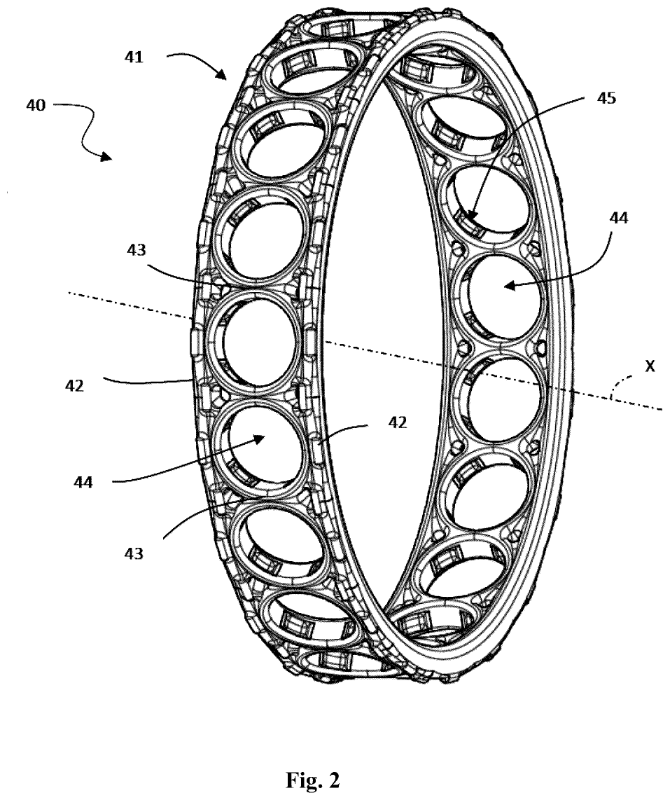

With reference to FIG. 2, the cage 40 has an annular shape defining a main axis of inertia or reference axis, which is coincident with the central rotation axis X of the bearing unit 30. The retaining cage 40 has a one-piece annular body 41 that forms two rings 42, one ring for each axial end, connected by bridges 43.

The annular body 41 of the cage 40 can be made of any suitable material, in particular any material suitable for additive manufacturing, for example plastic, ceramic or metal material. An example of a material preferably used is a composite material based on cotton fibers impregnated with a phenolic resin.

The two rings 42 and the bridges 43 delimit a plurality of through-cavities 44 or pockets separated in pairs by the bridges 43 and each framed by the two rings 42. A radially outer surface 44′ of the cavity 44 delimits the boundary of the cavity with respect to the two rings 42 and the pair of bridges 43. The pockets 44 house respective rolling bodies 32, in particular balls, in order to position and hold the rolling bodies.

Each cavity 44 has a polar plane PP and an equatorial plane PE, both perpendicular to the annular body 41. Each cavity 44 has a center O at the intersection of these two planes. The centers O of the pockets are all located at an equal distance from the central rotation axis X.

An aspect of the present disclosure is to optimize the topology of the cage 40, in particular a cage for a super-precision angular-contact bearing unit able to operate optimally at high speed (with a NDm speed factor of approximately 3 million).

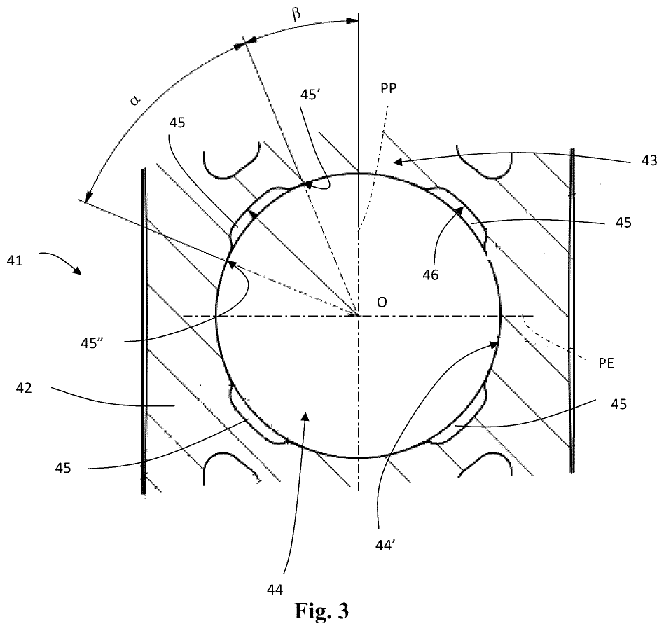

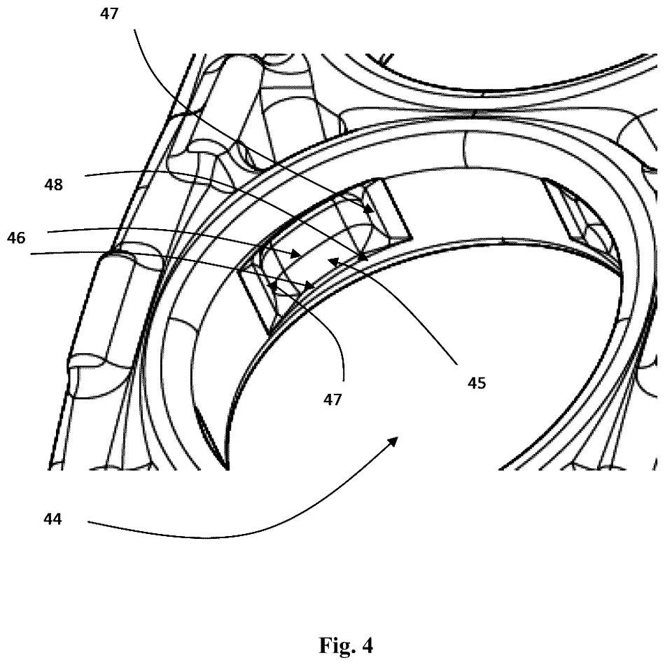

With reference to FIGS. 3 and 4, the disclosure is focused on optimizing the cavity 44 and the contact with the rolling bodies to reduce the friction generated by the contacts between the cage and the rolling bodies and to facilitate the flow of the lubricating grease using specially designed local reservoirs.

For this purpose, each cavity 44 has a plurality of recesses 45, of substantially square section, arranged circumferentially along the radially outer cylindrical surface 44′ of the cavity 44. The recesses 45 are circumferentially equidistant from each other. They have a substantially cylindrical bottom surface 46 radially outside the cylindrical surface 44′ of the cavity 44 delimited by a pair of axial surfaces 47 and a pair of tangential surfaces 48.

These recesses are configured to reduce the surface area of the cavity 44 in contact with the respective rolling body. In fact, since the pockets are recessed, i.e. they are formed by removing material from the annular body 41, the area of the cylindrical surface 44′ of the cavity 44 in contact with the balls is reduced, since the bottom surface 46 of the recesses 45 cannot be in contact with the rolling bodies. The pockets also ensure that the lubricating grease is prevented from leaking away from the contact zone with the rolling bodies, as is the case in known solutions wherein the geometry of the component does not create lubricant reservoirs.

According to a preferred embodiment illustrated in FIGS. 3 and 4 mentioned above, there are four recesses 45 and each pocket extends circumferentially over an angular width «, for example 45°. An end edge 45′ of each recess 45 is at an angular distance B, for example 22.5°, from the polar plane PP of the cavity 44. As a result, the second end 45″ of each recess 45 is also at the same angular distance of 22.5° from the equatorial plane PE. According to this embodiment, therefore, the recess 45 is angularly equidistant from the two planes PP, PE.

In total, therefore, the four recesses 45 angularly cover 180° of the full 360° of the cylindrical surface 44′ of the cavity 44. According to this embodiment, therefore, the cylindrical surface 44′ of the cavity 44 in contact with the rolling bodies is reduced by 50%.

This improved performance of the cage is due to the optimization of the topology of the cage, which is a process that combines design tools and FEM calculations and enables highly customized shapes to be realized. The principle of topology optimization has been applied to a cage for super-precision angular-contact ball bearings, assuming that the component is manufactured using additive manufacturing techniques. This enables all possible complex geometries resulting from the optimized topology design to be realized.

Thus, although the invention is applicable to any method of manufacturing the bearing unit cage, given the particular geometry of the cage, as described above, the aforementioned invention is particularly suitable for a cage of a bearing unit in which the body is obtained by additive manufacturing.

One advantage of the disclosed bearing cage is that the entire cage can be obtained using a known injection molding process or, preferably, using other processes such as additive manufacturing. Another advantage is the reduction of the surface area of the pockets directly affected by contact with the rolling bodies, and therefore reduction of friction losses between the cage and the rolling bodies. A further advantage is the creation of reservoirs for containing the lubricating grease, which can provide lubricant to the contact areas by centrifugation due to the motion of the cage.

Numerous other variants exist in addition to the embodiments of the invention described above. The embodiments are provided solely by way of example and do not limit the scope of the invention, its applications or its possible configurations. Indeed, although the description provided above enables the person skilled in the art to carry out the present invention at least according to one example configuration thereof, numerous variations of the components described could be used without thereby departing from the scope of the invention, as defined in the attached claims interpreted literally and/or according to their legal equivalents.

What is claimed is:

1. A bearing unit having a central rotation axis and comprising:
a radially outer ring,
a radially inner ring,
a retaining cage configured to retain a plurality of rolling bodies between the inner ring and the outer ring, the retaining cage being centered on the radially outer ring and comprising:
a one-piece annular body including a first ring connected to a second ring by a plurality of bridges, and
a plurality of pockets in the annular body each configured to house and retain one of the plurality of rolling bodies, the pockets being framed by the first ring and the second ring and located between adjacent pairs of the bridges,
wherein each of the plurality of pockets has a side wall having a circumference, and
wherein a plurality of circumferentially spaced circumferentially extending recesses of substantially square section are located in the side wall of each pocket.

2. The bearing unit according to claim 1,
wherein the recesses are circumferentially equidistant from each other.

3. The bearing unit according to claim 2,
wherein the side wall of each of the plurality of pockets lies on a first cylinder, and
wherein each recess has a bottom surface lying on a second cylinder.

4. The bearing unit according to claim 3,
wherein the second cylinder has a radius larger than a radius of the first cylinder and is coaxial with the first cylinder.

5. The bearing unit according to claim 4,
wherein first and second parallel side walls extend from the bottom surface toward the pocket, and
wherein first and second arcuate end walls extend from the bottom surface toward the pocket.

6. The bearing unit according to claim 5,
wherein the plurality of circumferentially spaced recesses are exactly four recesses.

7. The bearing unit according to claim 5, wherein each pocket has an angular width of about 45°.

8. The bearing unit according to claim 7,
wherein an equatorial plane including the central rotation axis and a polar plane perpendicular to the equatorial plane divide each pocket into four quadrants, and
wherein each recess is centered between the equatorial plane and the polar plane.

9. The bearing unit according to claim 1,
wherein the annular body of the cage is formed by an additive manufacturing process.

10. The bearing unit according to claim 1,
wherein the annular body is formed from cotton fibers impregnated with a phenolic resin.

11. A bearing unit having a central rotation axis and comprising
a radially outer ring,
a radially inner ring,
a retaining cage configured to retain a plurality of rolling bodies between the inner ring and the outer ring, the retaining cage being centered on the radially outer ring and comprising:
a one-piece annular body including a first ring connected to a second ring by a plurality of bridges, and
a plurality of pockets in the annular body each configured to house and retain one of the plurality of rolling bodies, the pockets being framed by the first ring and the second ring and located between adjacent pairs of the bridges,
wherein each of the plurality of pockets has a side wall lying on a first cylinder,
wherein a plurality of circumferentially spaced circumferentially extending recesses are formed in the side wall of each pocket,
wherein each recess has a bottom wall lying on a second cylinder coaxial with the first cylinder and having a diameter greater than a diameter of the first cylinder, and
wherein a first sidewall and a second side wall parallel to the first side wall extend from the bottom wall of each recess toward the pocket.
